(19) United States
(12) Patent Application Publication
(10) Pub. No.: US 2014/0089207 A1
(43) Pub. Date: Mar. 27, 2014

(54) SYSTEM AND METHOD FOR PROVIDING HIGH LEVEL VIEW TRACKING OF CHANGES IN SCA ARTIFACTS

(71) Applicant: ORACLE INTERNATIONAL CORPORATION, Redwood Shores, CA (US)

(72) Inventors: Ignacio Manzano, Buenos Aires (AR); Juan Vimberg, Buenos Aires (AR); Nicolas Damonte, Buenos Aires (AR); Maria Mare, Buenos Aires (AR)

(73) Assignee: Oracle International Corporation, Redwood Shores, CA (US)

(21) Appl. No.: 13/736,906

(22) Filed: Jan. 8, 2013

Related U.S. Application Data
(60) Provisional application No. 61/706,707, filed on Sep. 27, 2012.

(51) Int. Cl. G06Q 10/10

(52) U.S. Cl. CPC G06Q 10/103
USPC 705/301

(57) ABSTRACT

Systems and methods for providing high level view tracking of changes in SCA artifacts are provided. A system comprises a project history tool executing on a computer, which includes an extensible model which maps artifacts to files. When the project history tool receives a project history, the project history tool analyzes the project history to identify files which have changed, identifies, using an extensible model, one or more artifacts associated with the changed files, groups the changed files based on the one or more artifacts, and creates a component-oriented view of the project history

### CROSS-REFERENCE TO RELATED APPLICATIONS

The present application claims priority from U.S. Provisional Patent Application No. 61/706,707, filed on Sep. 27, 2012, titled “SYSTEM AND METHOD FOR PROVIDING HIGH LEVEL VIEW TRACKING OF CHANGES IN SCA ARTIFACTS,” by Ignacio Manzano et al., which is herein incorporated by reference in its entirety for all purposes.

### BACKGROUND

Business process management (BPM) tools, such as Oracle Business Process Management Suite, enable business users to design and model various business processes. However, when business users design these business processes, they typically think at the business level, without much, if any, knowledge of the underlying components they are actually modeling. Typically, any given business artifact is associated with several different underlying files. As a consequence when a user modifies an artifact, several files can be modified.

Hiding this complexity from the business-user, while beneficial to the business-user, can make auditing a project history a difficult task since typical auditing tools provide changes at the file-level. Since business users are not generally familiar with this level of detail, they do not know which files correspond to which artifact. Thus, providing file-level granularity of changes is of limited use to the typical business user.

### SUMMARY

In accordance with an embodiment, a project history tool can create a component-oriented view of the changes to a project, based on the list of changed files in that project. This component-oriented view can enable business users to view changes on an artifact by artifact basis. The business user can then select an artifact and see what changes have been made to which files associated with that artifact. This provides a higher level of abstraction more familiar to the business users, while also providing a more detailed view for technical users. This improves the BPM process design user experience especially for business-users by allowing them to browse the history of changes of a given project. By providing tools that support different levels of abstraction, a broader segment of non-technical users can be involved in the design of business-processes.

In accordance with an embodiment, a system comprises a project history tool executing on a computer, which includes an extensible model which maps artifacts to files. When the project history tool receives a project history, the project history tool identifies one or more artifacts associated with the project, analyzes the project history to identify files associated with each of the one or more artifacts, and creates a component-oriented view of the project history

### BRIEF DESCRIPTION OF THE DRAWINGS

FIG. 1 shows a project history tool, in accordance with an embodiment.

FIG. 2 shows a simplified diagram of how artifact information is stored, in accordance with an embodiment of the present invention;

FIG. 3 shows a first exemplary user interface, in accordance with an embodiment of the present invention;

FIG. 4 shows a second exemplary user interface, in accordance with an embodiment of the present invention;

FIG. 5 shows a third exemplary user interface, in accordance with an embodiment of the present invention;

FIG. 6 shows screenshots of an exemplary user interface, in accordance with an embodiment of the present invention;

FIG. 7 shows a method for tracking changes to service component architecture (SCA) artifacts, in accordance with an embodiment;

FIG. 8 is a simplified block diagram illustrating components of a system environment that may be used in accordance with some embodiments of the present invention; and

FIG. 9 is a simplified block diagram of a computing system that may be used in accordance with embodiments of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

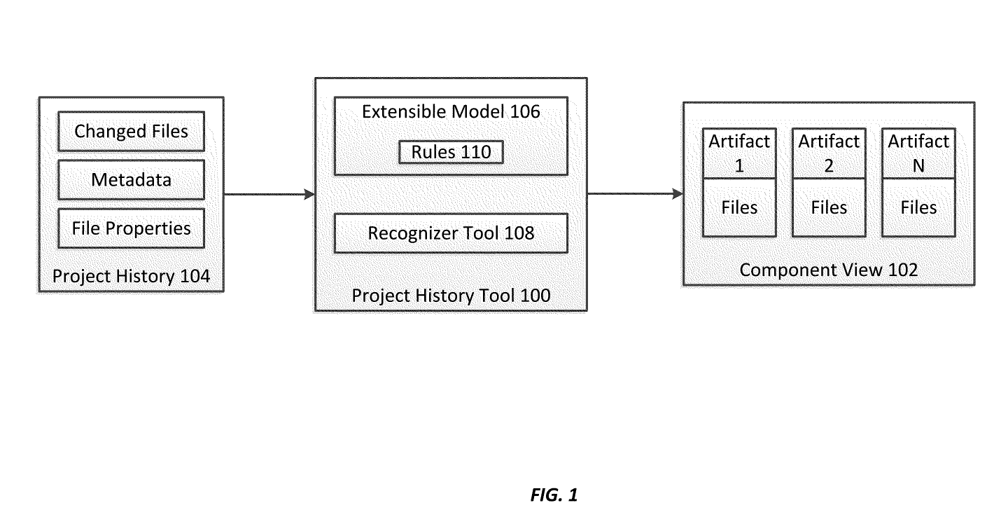

FIG. 1 shows a project history tool, in accordance with an embodiment. In accordance with an embodiment, a project history tool 100 can create a component-oriented view 102 of a project's history 104, based on the list of changed files in that project. This component-oriented view can enable business users to view changes on an artifact by artifact basis. The business user can then select an artifact and see what changes have been made to which files associated with that artifact. This provides a higher level of abstraction more familiar to the business users, while also providing a more detailed view for technical users. This improves the BPM process design user experience especially for business-users by allowing them to browse the history of changes of a given project. By providing tools that support different levels of abstraction, a broader segment of non-technical users can be involved in the design of business-processes.

In accordance with an embodiment, an artifact can refer to a type of activity in a business process. For example, a business process may include a step where loan application details are entered by a person and then a credit check is performed based on those details. The loan application detail entry step may be represented by a human task artifact and the credit check step may be represented by a web service artifact. Other artifacts can include a business process model and notation (BPMN) process, rules, and other activities.

As shown in FIG. 1, the project history tool can include an extensible model 106 that maps particular files to business artifacts, and a recognizer tool 108 that builds the business-oriented view of changes from the list of changed files using the defined models.

The extensible model can include a plurality of rules 110, based on files properties (e.g. file name, extension or path), file content, and the business-artifact associated with those files. The rules can be used to determine which files map to a particular artifact. The model is extensible because each artifact can have its own independent set of rules which can be easily customized. For example, if a new artifact is added, a new set of rules can be created based on which files are associated with the new artifact.

When a project history is analyzed by the project history tool 100, the recognizer tool 108 can iterate over the extensible model 106 and a list of changed files 112 in the project history to create a business-oriented view of each artifact defined in the extensible model. The recognizer tool can use one or more of file properties 112 and change meta-data 114 (e.g. date of change, author, the action performed over an asset, etc.) included in the project history 104. Additionally, the recognizer tool can bundle and present files that do not belong to any of the defined business artifacts.

The output of the project history tool is the component oriented view 102 in which each artifact in the extensible model 106 is grouped with its associated files. In accordance with an embodiment, when the user selects a particular artifact in the component-oriented view, a detailed view of the files associated with that artifact can be shown. This way, the project history tool can provide both an abstract view, for business users, and a more detailed view for more technical-oriented users who may benefit from a more rich but complex view of the project history.

Additionally, in accordance with an embodiment, an API is provided to let users query for a particular set of changes matching a given criteria. An advantage is that users can specify changes over a particular business artifact.

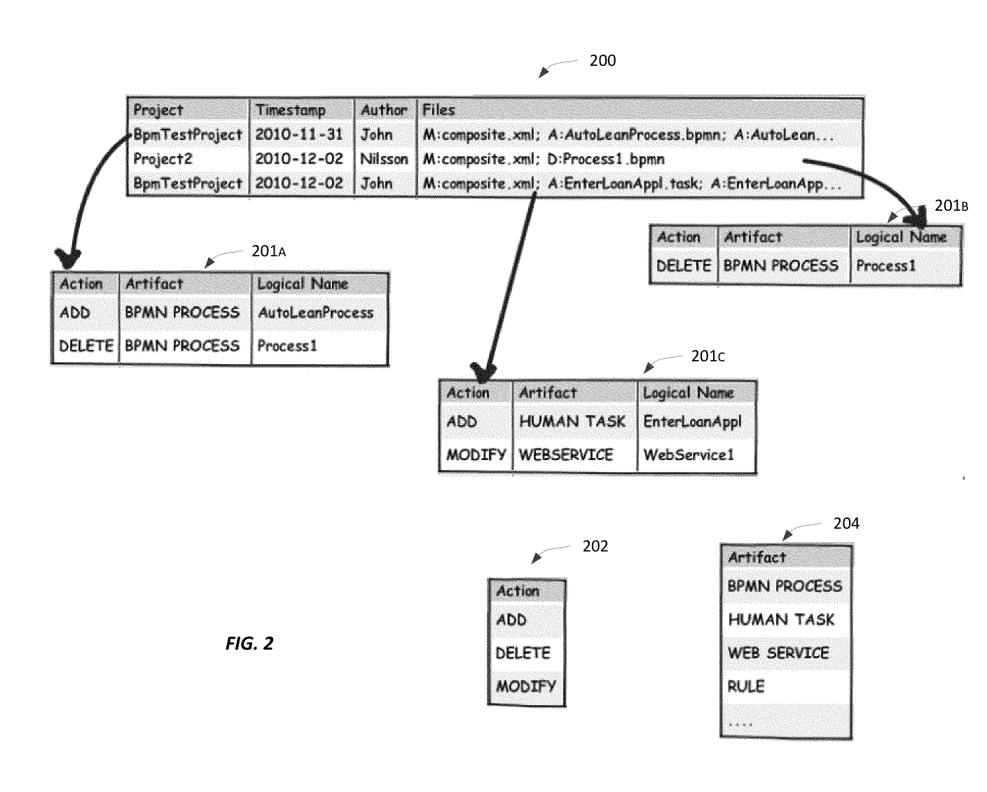

FIG. 2 shows a simplified diagram of how artifact information is stored, in accordance with an embodiment of the present invention. As described above, the project history tool can provide different views at different levels of granularity. As shown at 200, information about each project can be stored in a master table. The information provided in each entry can include the author, timestamp of the change, the operation performed on the project and a list of the involved artifacts. When a particular project is selected, changes to the project can be shown in a detail tables 201a, 201b, and 201c. The changes to the project can include an action, such as add, delete and modify, as shown at 202, and an artifact name as shown at 204. The list of changes can be provided as a functional abstraction of the artifacts involved, so that the user can more easily understand the modifications performed.

In accordance with an embodiment, each time a project is published, the differences between the new published version and the previous one can be recorded as part of the project's history of changes. The user can browse through the history of changes of each project. Each entry can include the following information:

Project: The project name related to the entry;

Timestamp: The date and time of the newly created entry; and

Author: The user responsible for the new published version of the project that created this entry.

Every entry with these attributes represents one change in the change history of the project. Along with these entries, more detailed information can also be provided. This more detailed information can include a list of modified artifacts and the operation performed on each one, including:

Action: The operation performed on the artifact (coded as ADD, DELETE, MODIFY);

Artifact: The type of artifact involved. This can be a coded value, see the Artifact table below; and

Logical Name: This is the logical name of the artifact, for example a particular Human Task may be called LoanEntry.

In accordance with an embodiment, a list of the affected artifacts or files can also be provided. A new log entry can be created every time a public share or template is published. This means that local changes made to projects between publications may not be taken into account for logging. For example, when using Oracle BPM Studio, local changes to projects may not be part of the history of changes until the user publishes the project to a metadata services (MDS), or similar, repository. Similarly, when using Oracle Business Process Composer, local changes to a draft project may not be part of the history of changes until the user publishes his project.

Table 1, below, shows an extensible model, in accordance with an embodiment. As shown in Table 1, each logical item (artifact) can be associated with one or more rules. As shown below, these rules can include particular file types or other rules which can be used to identify particular files. For example, a rule could identify files based on content, such as by identifying accounting files based on their content.

TABLE 1

| Logical Item | Related files |
|---|---|
| Process | *.bpmn, *.wsdl, *.componentType, |
| | *_doc.xml, *Documentation.xml |
| BPEL | *.bpel, *.wsdl, *.componentType, *.xsd |
| Human Task | *.task, *.componentType, |
| | *WorkflowTask.xsd, *Payload.xsd |
| Business Rules | *.rules, *.componentType, *.decs |
| Activity Guide | /activityGuide.agdl, |
| | /ActivityGuide.properties |
| Organization | /organization.xml |
| Measurements | /measurements.xml, |
| | /measurementActions.xml |
| Business Object | /businessCatalog/*/*.wsdl, |
| | /businessCatalog/*/*.xsd |
| Resources | Any file not recognized in any of the previous |
| | categories |

In accordance with an embodiment, the items displayed in each artifact's history correspond to the files matching the rules in bold shown in Table 1. Files in the Resources category may not be grouped and each one of them may be persisted as a different logical item. Additionally, not all related files may be shown. Depending on a file property (type, size, name, etc.) files could be excluded from recognition. This feature is particularly useful to prevent performance issues, since to make full recognition each artifact may need to be opened in memory, which could require an undue amount of overhead.

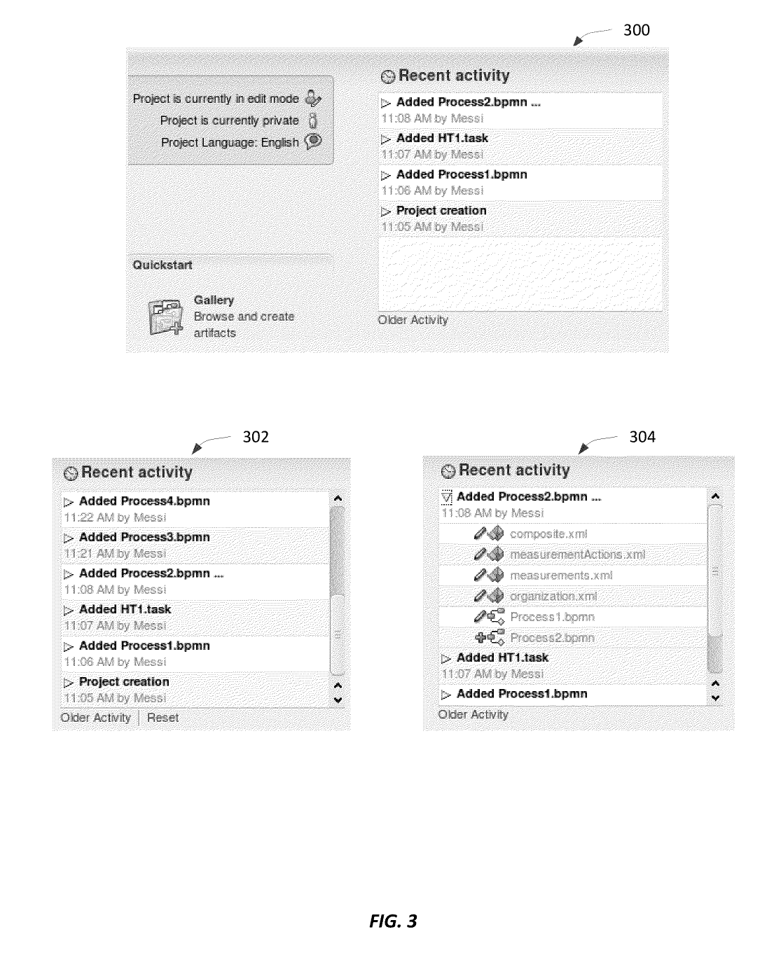

FIG. 3 shows a first exemplary user interface, in accordance with an embodiment of the present invention. As shown at 300, the user interface can include a project welcome page which displays information related to a particular project. Information such as the mode the project is in, the language of the project and whether the project is currently private can be shown. Additionally, the recent activity performed on the project can be displayed, as shown at in more detail at 302. The list can show the project creation and any project save action performed by a user. It includes the list of modified artifacts, which means, all the ones that were modified, removed or added by the save action. In accordance with an embodiment, the following conventions can be followed for changes shown in the list of recent activity:

Project Creation: The first entry for a project is a project creation action, so “Project Creation” can be shown as the title.

For any other change:
1) If there is any activity on a BPMN artifact: The title can be one of the BPMN changes (e.g., “Added Process1.bpmn”)
2) If there is NO activity on BPMN but there is at least one on a RULE, Human Task or BPEL: The title can show one of the modified artifacts (e.g., “Added HT1.task”)
If neither 1) nor 2) exists, then the title can be: “Modified Resources”
Note: If there is more than one high level artifact (BPMN, BPEL, RULE, Human Task), the title can show “ . . . ” at the end of the title.

In accordance with an embodiment, a different table row can be used to represent each user activity change. Each row can include the title and as subtitle the author name and the date of the change in a human-readable format. The user can select a row to expand it and see the files associated with the modified artifacts, as shown at 304. In accordance with an embodiment, the recent history list can show the latest ten changes by default. The user can then select older activity to see additional, older changes. A reset link can be provided to return the list to its default length.

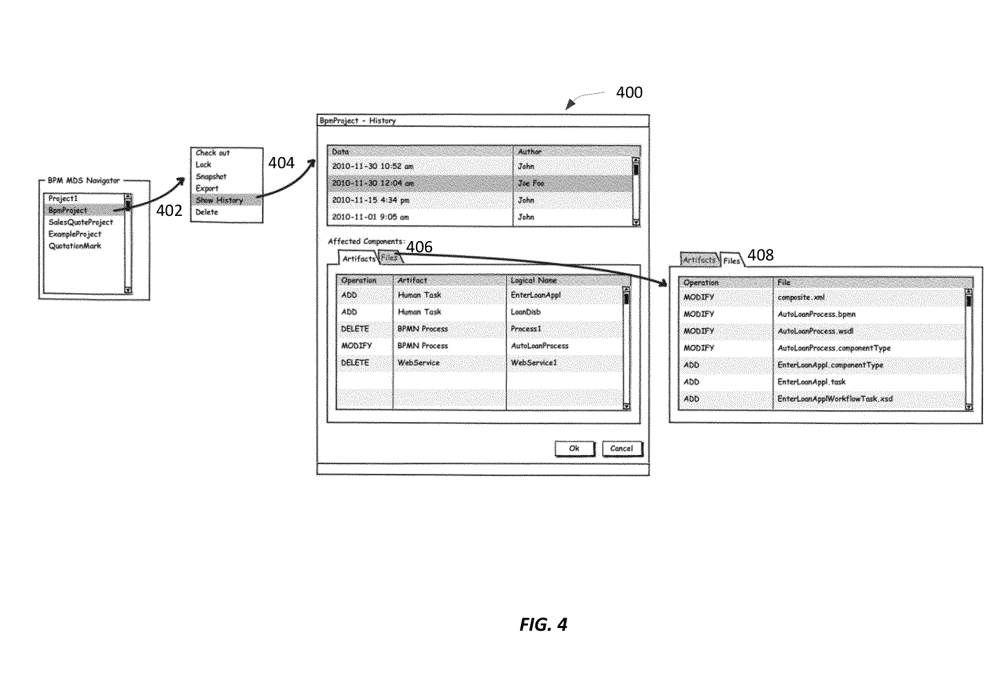

FIG. 4 shows a second exemplary user interface, in accordance with an embodiment of the present invention. As shown in FIG. 4, a user can navigate user interface 400 to select a particular project 402 from a list of projects shown in user interface 400. The user can then choose an action to be performed on the selected project, such as show history 404. The user interface 400 can then display the project's history at the artifact level or at the file level. In accordance with an embodiment, as shown in FIG. 4, the artifact level and file level can be displayed in different tabs 406, 408.

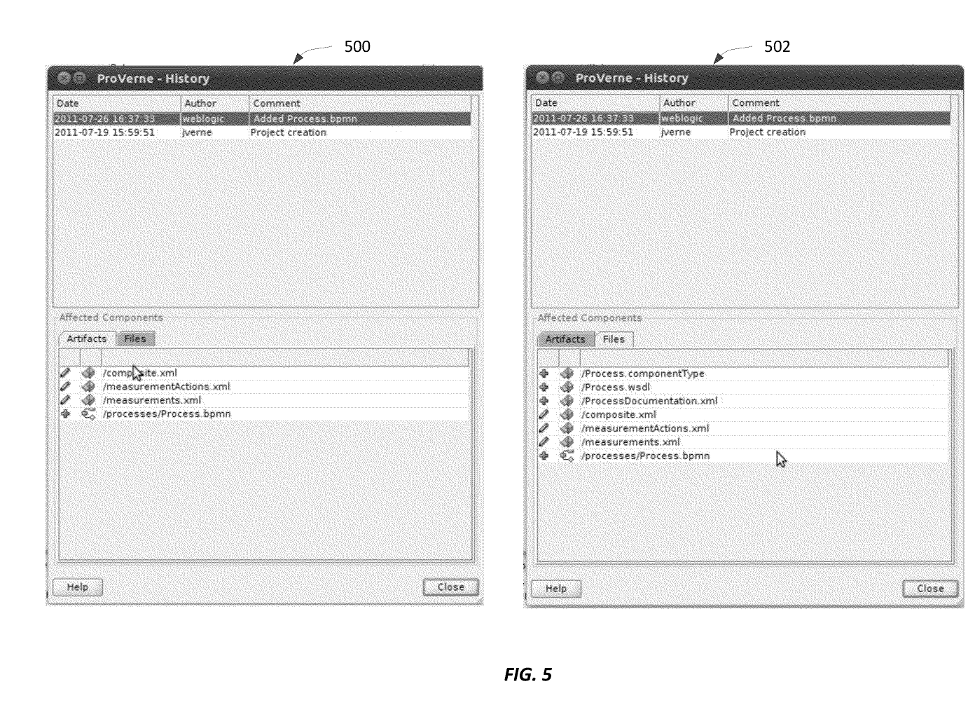

FIG. 5 shows screenshots of an exemplary user interface, in accordance with an embodiment of the present invention. FIG. 5 shows a particular implementation of a user interface, such as user interface 400 discussed above. As shown at 500, an artifacts tab can show an artifact-level view of changes to a particular project. At 502, a files tab can show a file-level view of changes to that project.

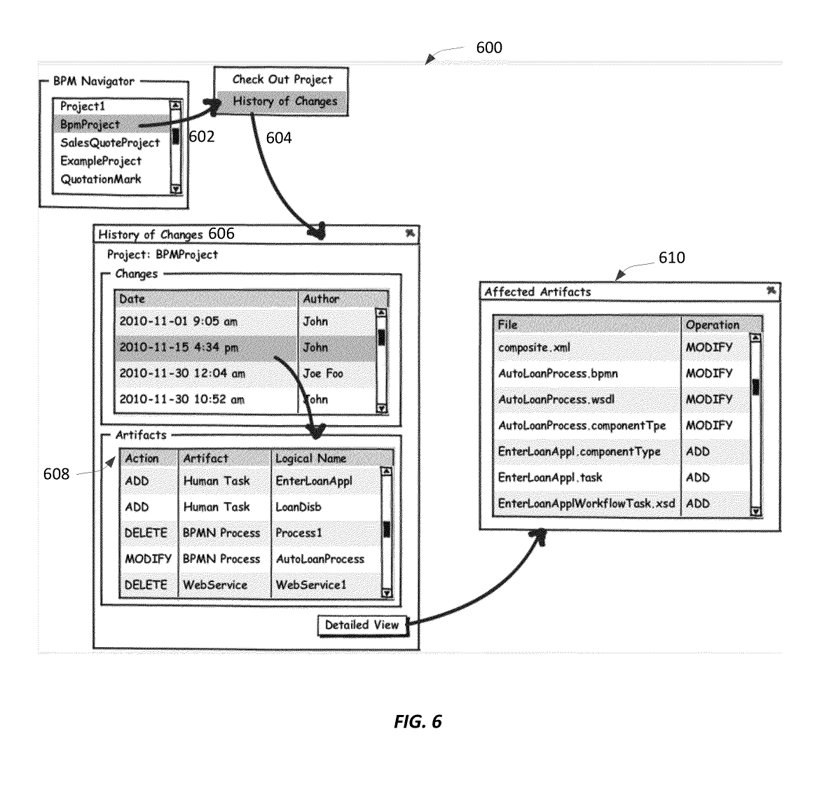

FIG. 6 shows a third exemplary user interface, in accordance with an embodiment of the present invention. As shown in FIG. 6, a user can navigate user interface 600 to select a particular project 602 and then select an action 604 to be performed on the selected project. As before, the action can be to show the history of the project 606. The user interface 600 can then display the project's history at the artifact level 608 or at the file level 610. In accordance with an embodiment, the project history can initially show the changed artifacts 608 in the project. An artifact can be selected and the user can then select a detailed view of the artifact to be shown the file level changes 610.

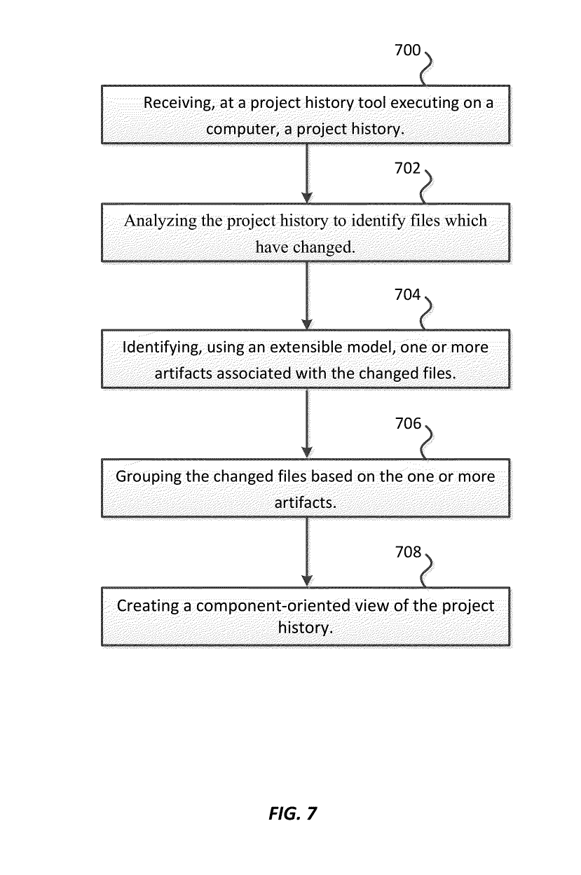

FIG. 7 shows a method for tracking changes to service component architecture (SCA) artifacts, in accordance with an embodiment. At 700, a project history tool executing on a computer receives a project history. At 702, the project history is analyzed to identify files which have changed. At 704 one or more artifacts associated with the changed files are identified, using an extensible model. At 706, the changed files are grouped based on the one or more artifacts. At 708, a component-oriented view of the project history is created. As described above, the component-oriented view can include the one or more artifacts and each artifact's associated files. Additionally, the extensible model can include definitions for a plurality of artifacts, each associated with a plurality of rules which define which files are associated with which artifacts based on file type and file content. Further, a recognizer tool can iterate over the project history and identify the files associated with each of the one or more artifacts using the extensible model.

### Querying and Pagination

The API can permit clients to query for a particular set of changes matching a given Criteria. Clients can query changes specifying any combination of: Project Name; Author; From Timestamp: Changes made after the specified date (including the specified); and To Timestamp: Changes made before the specified date (excluding the specified). Additionally, the last N modified artifacts of a project can be requested. These modified artifacts could each be associated with a single project change or could be across multiple changes. For example, if the last 15 modified artifacts are requested, all 15 artifacts could be associated with the same project change, or they could be associated with 15 different project changes.

In accordance with an embodiment, when querying a maximun number of results can be specified. This can be done by using 3 parameters: Maximun number of results per page; From Page (including the specified); and To Page (excluding the specified). For example if the user requests Max number of results per page=5, From Page=2 and To Page=4, the query can retrieve 10 results corresponding to page 2 and page 3. This is can be useful for avoiding the load of a large amount of data associated with a query, and can help users with pagination of the results of the query.

In accordance with an embodiment, a new table can be created for storing entries as projects are published. The list of changes can be provided as a functional abstraction of the artifacts involved. The finest-grain view can be at the artifact level. In some embodiments, the history of changes may record only the names of the artifacts (logical and real) and not the contents of the modified artifacts. In these embodiments, a “diff” representing the difference between different versions of a specific project may not be available and the user may not be able to compare the contents of artifacts between two different versions.

In accordance with an embodiment, BPM Studio can need the credentials and the endpoint of the history of changes service. In order to achieve that, a metadata services (MDS) Connection panel can be expanded for the user to introduce this information. If two phase commit is not supported by MDS and the log table, a new entry in the log table can be created once the project has been successfully committed.

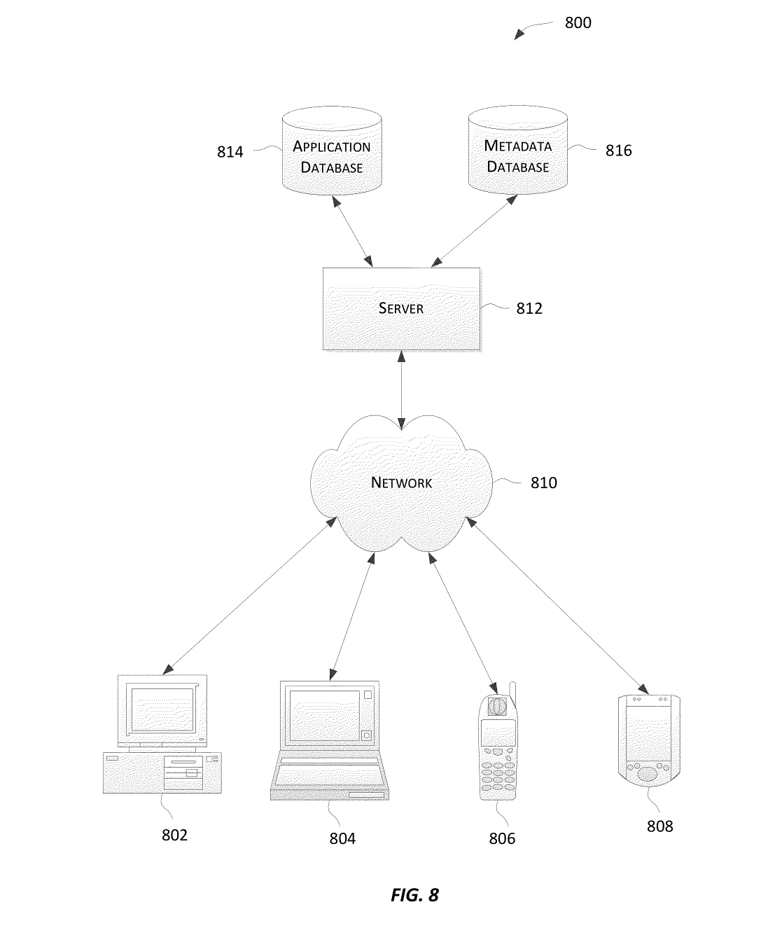

FIG. 8 is a simplified block diagram illustrating components of a system environment 800 that may be used in accordance with some embodiments of the present invention. As shown, system environment 800 includes one or more client computing devices 802, 804, 806, 808, which are configured to operate a client application such as a web browser, proprietary client (e.g., Oracle Forms), or the like. In various embodiments, client computing devices 802, 804, 806, and 808 may interact with a server 812.

Client computing devices 802, 804, 806, 808 may be general purpose personal computers (including, by way of example, personal computers and/or laptop computers running various versions of Microsoft Windows and/or Apple Macintosh operating systems), cell phones or PDAs (running software such as Microsoft Windows Mobile and being Internet, e-mail, SMS, Blackberry, or other communication protocol enabled), and/or workstation computers running any of a variety of commercially-available UNIX or UNIX-like operating systems (including without limitation the variety of GNU/Linux operating systems). Alternatively, client computing devices 802, 804, 806, and 808 may be any other electronic device, such as a thin-client computer, Internet-enabled gaming system, and/or personal messaging device, capable of communicating over a network (e.g., network 810 described below). Although system environment 800 is shown with four client computing devices, any number of client computing devices may be supported. Other devices such as devices with sensors, etc. may interact with server 812. Authorization requests may be received from one or more client devices.

System environment 800 may include a network 810. Network 810 may be any type of network familiar to those skilled in the art that can support data communications using any of a variety of commercially-available protocols, including without limitation TCP/IP, SNA, IPX, AppleTalk, and the like. Merely by way of example, network 810 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

System environment 800 also includes one or more server computers 812 which may be general purpose computers, specialized server computers (including, by way of example, PC servers, UNIX servers, mid-range servers, mainframe computers, rack-mounted servers, etc.), server farms, server clusters, or any other appropriate arrangement and/or combination. In various embodiments, server 812 may be adapted to run one or more services or software applications described in the foregoing disclosure.

Server 812 may run an operating system including any of those discussed above, as well as any commercially available server operating system. Server 812 may also run any of a variety of additional server applications and/or mid-tier applications, including HTTP servers, FTP servers, CGI servers, Java servers, database servers, and the like. Exemplary database servers include without limitation those commercially available from Oracle, Microsoft, Sybase, IBM and the like.

System environment 800 may also include one or more databases 814, 816. Databases 814, 816 may reside in a variety of locations. By way of example, one or more of databases 814, 816 may reside on a storage medium local to (and/or resident in) server 812. Alternatively, databases 814, 816 may be remote from server 812, and in communication with server 812 via a network-based or dedicated connection. In one set of embodiments, databases 814, 816 may reside in a storage-area network (SAN) familiar to those skilled in the art. Similarly, any necessary files for performing the functions attributed to server 812 may be stored locally on server 812 and/or remotely, as appropriate. In one set of embodiments, databases 814, 816 may include relational databases, such as Oracle 10g, 11g, Release 12, etc., which are adapted to store, update, and retrieve data in response to SQL-formatted and other commands. In one embodiment, policies configured to controlling a set of resources may be stored by one of the databases.

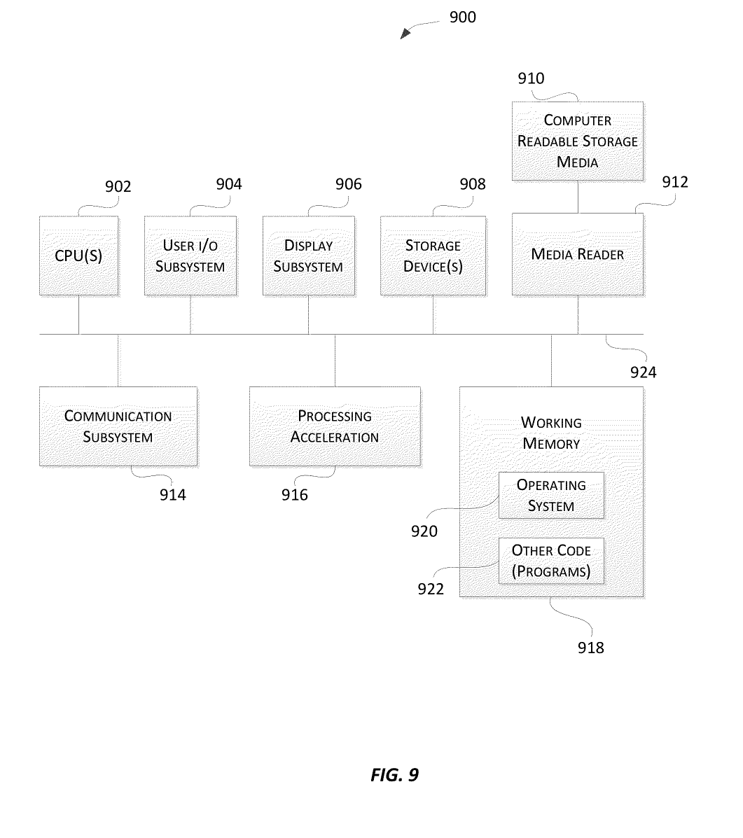

FIG. 9 is a simplified block diagram of a computing system 900 that may be used in accordance with embodiments of the present invention. For example, the system depicted in FIG. 2 may be implemented using a system such as system 900. Computer system 900 is shown comprising hardware elements that may be electrically coupled via a bus 924. The hardware elements may include one or more central processing units (CPUs) 902, one or more input devices 904 (e.g., a mouse, a keyboard, etc.), and one or more output devices 906 (e.g., a display device, a printer, etc.). The CPUs may include single or multicore CPUs. Computer system 900 may also include one or more storage devices 908. By way of example, the storage device(s) 908 may include devices such as disk drives, optical storage devices, and solid-state storage devices such as a random access memory (RAM) and/or a read-only memory (ROM), which can be programmable, flash-updateable and/or the like.

Computer system 900 may additionally include a computer-readable storage media reader 912, a communications subsystem 914 (e.g., a modem, a network card (wireless or wired), an infra-red communication device, etc.), and working memory 918, which may include RAM and ROM devices as described above. In some embodiments, computer system 900 may also include a processing acceleration unit 916, which can include a digital signal processor (DSP), a special-purpose processor, and/or the like.

Computer-readable storage media reader 912 can further be connected to a computer-readable storage medium 910, together (and, optionally, in combination with storage device(s) 908) comprehensively representing remote, local, fixed, and/or removable storage devices plus storage media for temporarily and/or more permanently containing computer-readable information. Communications system 914 may permit data to be exchanged with network 1810 and/or any other computer described above with respect to system environment 1800.

Computer system 900 may also comprise software elements, shown as being currently located within working memory 918, including an operating system 920 and/or other code 922, such as an application program (which may be a client application, Web browser, mid-tier application, RDBMS, etc.). In an exemplary embodiment, working memory 918 may include executable code and associated data structures such as memory structures used for processing authorization requests described above. It should be appreciated that alternative embodiments of computer system 900 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data. Examples of storage and computer-readable media include RAM, ROM, EEPROM, flash memory or other memory technology, CD-ROM, digital versatile disk (DVD) or other optical storage, magnetic cassettes, magnetic tape, magnetic disk storage or other magnetic storage devices, or any other memory medium which can be used to store the desired information and which can be read by a computer. Storage media and computer readable media may include non-transitory memory devices.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims.

What is claimed is:

1. A method for tracking changes to service component architecture (SCA) artifacts, the method comprising:
receiving, at a project history tool executing on a computer, a project history;
analyzing the project history to identify files which have changed;
identifying, using an extensible model, one or more artifacts associated with the changed files;
grouping the changed files based on the one or more artifacts; and
creating a component-oriented view of the project history.

2. The method of claim 1 wherein the component-oriented view includes the one or more artifacts and each artifact's associated files.

3. The method of claim 1 wherein the extensible model includes definitions for a plurality of artifacts, each associated with a plurality of rules.

4. The method of claim 3 wherein the plurality of rules define which files are associated with which artifacts based on file type and file content.

5. The method of claim 1 wherein the project history tool further comprises a recognizer tool which iterates over the project history and identifies the files associated with each of the one or more artifacts using the extensible model.

6. The method of claim 1 further comprising a graphical user interface (GUI) which is operable to display the component-oriented view of the project history.

7. The method of claim 6 wherein the component-oriented view of the project history can be selectively displayed at an artifact level or a file level.

8. A system for tracking changes to service component architecture (SCA) artifacts comprising:
a computer, including a computer readable storage medium and processor;
a project history tool executing on the computer, which includes an extensible model which maps artifacts to files;
wherein when the project history tool receives a project history, the project history tool
analyzes the project history to identify files which have changed,
identifies, using an extensible model, one or more artifacts associated with the changed files,
groups the changed files based on the one or more artifacts, and
creates a component-oriented view of the project history.

9. The system of claim 8 wherein the component-oriented view includes the one or more artifacts and each artifact's associated files.

10. The system of claim 8 wherein the extensible model includes a plurality of artifacts, each associated with a plurality of rules.

11. The system of claim 10 wherein the plurality of rules define which files are associated with which artifacts based on file type and file content.

12. The system of claim 8 wherein the project history tool further comprises a recognizer tool which iterates over the project history and identifies the files associated with each of the one or more artifacts using the extensible model.

13. The system of claim 8 further comprising a graphical user interface (GUI) which is operable to display the component-oriented view of the project history.

14. The system of claim 13 wherein the component-oriented view of the project history can be selectively displayed at an artifact level or a file level.

15. A non-transitory computer readable storage medium including instructions stored thereon which, when executed by a processor, cause the processor to perform the steps of:
receiving, at a project history tool executing on a computer, a project history;
analyzing the project history to identify files which have changed;
identifying, using an extensible model, one or more artifacts associated with the changed files;
grouping the changed files based on the one or more artifacts; and
creating a component-oriented view of the project history.

16. The non-transitory computer readable storage medium of claim 15 wherein the component-oriented view includes the one or more artifacts and each artifact's associated files.

17. The non-transitory computer readable storage medium of claim 15 wherein the extensible model includes definitions for a plurality of artifacts, each associated with a plurality of rules.

18. The non-transitory computer readable storage medium of claim 17 wherein the plurality of rules define which files are associated with which artifacts based on file type and file content.

19. The non-transitory computer readable storage medium of claim 15 wherein the project history tool further comprises a recognizer tool which iterates over the project history and identifies the files associated with each of the one or more artifacts using the extensible model.

20. The non-transitory computer readable storage medium of claim 15 further comprising a graphical user interface (GUI) which is operable to display the component-oriented view of the project history, wherein the component-oriented view of the project history can be selectively displayed at an artifact level or a file level.
